(19) United States
(12) Patent Application Publication
(10) Pub. No.: US 2009/0071452 A1
(43) Pub. Date: Mar. 19, 2009

(54) Bi-fuel Engine Using Hydrogen

(76) Inventors: Patrick Joseph Phlips, Bloomfield Hills, MI (US); William Francis Stockhausen, Northville, MI (US)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/855,426

(22) Filed: Sep. 14, 2007

(51) Int. Cl. F02B 43/00

(52) U.S. Cl. 123/575

(57) ABSTRACT

A method for controlling an internal combustion engine is disclosed in which a first fuel, hydrogen, is supplied under a first set of engine operating conditions and a second fuel, such as: gasoline, gasoline mixed with alcohol, or gaseous hydrocarbons, are supplied under a second set of engine operating conditions. The first set of engine operating condition is below a threshold BMEP and the second operating condition is above the threshold BMEP. Alternatively, the first and second set of operating condition is based on temperature of a three-way catalyst coupled to the engine. When its temperature is greater than its light-off temperature, the second fuel is used.

### FIELD OF THE INVENTION

A method to operate an internal combustion engine which is supplied with both hydrogen fuel and another fuel is disclosed.

### BACKGROUND

Because of concerns about greenhouse gases that are emitted from carbon-containing fuels, such as gasoline, diesel, and alcohol fuels, there is keen interest in fueling motor vehicles with hydrogen, which produces water upon combustion. Hydrogen-fueled internal-combustion engines suffer from a low power output compared to gasoline or diesel powered engines due to hydrogen being a gaseous fuel which takes up much of the volume in the cylinder, particularly when compared to dense fuels like gasoline or diesel fuel. Furthermore, hydrogen combustion is limited to operating at an equivalence ratio of about 0.5 or less due to increasing combustion harshness and, if it is a concern, rapidly increasing NOx emission. An equivalence ratio of one is a stoichiometric ratio meaning that the proportion of fuel to air is such that all the oxygen and fuel could burn completely. An equivalence ratio of 0.5 is a lean ratio in which the amount of air supplied is double that needed to completely consume the fuel. Such a limit in equivalence ratio results in about half the fuel delivery as could be consumed by the amount of air in the chamber, and consequently about half of the torque developed by the engine than if at a stoichiometric proportion.

Equivalence ratio is defined as the mixture's fuel to air ratio (by mass) divided by the fuel to air ratio for a stoichiometric mixture. A stoichiometric mixture has an equivalence ratio of 1.0; lean mixtures are less than 1.0; and, rich mixtures are greater than 1.0.

### SUMMARY OF THE INVENTION

The inventors of the present invention have recognized that by operating on two fuels: hydrogen and gasoline, as an example, the engine could be operated on hydrogen at low torque levels and on gasoline at higher torque levels. Hydrogen combusts readily at very lean equivalence ratios and is well suited to burning robustly at very low torques with at most, a minimum of throttling. Gasoline is well suited to providing high torque because of its high energy density and ability to operate at stoichiometric. The inventors of the present invention propose a bifuel engine in which transitions are made between operating on hydrogen and another fuel.

The high torque fuel can be a hydrocarbon, such as natural gas, propane, gasoline, or alcohols, such as methanol or ethanol. Furthermore, combinations of the gaseous fuel or combinations of the liquid fuels may also be used, such as E85, a mixture of 85% ethanol with 15% gasoline. High torque fuels contain carbon, which upon combustion reacts to form carbon dioxide, a greenhouse gas. Because hydrogen produces only water as the product of combustion, it does not form a greenhouse gas. Thus, it is desirable to operate on hydrogen when possible and using the carbon containing fuels as needed to provide the desired torque.

A normalized engine torque commonly used by one skilled in the art is BMEP, brake mean effective pressure, which for 4-stroke engines is 2*P/(V*N), where P is brake power, V is displaced volume, and N is engine rpm.

A method to operate an internal combustion engine is disclosed in which a hydrogen fuel is supplied to the engine when the engine is at a first operating condition. A hydrocarbon fuel is supplied to the engine when the engine is at a second operating condition. The first operating condition is below a threshold BMEP and the second operating condition is above the threshold BMEP. When the engine is naturally aspirated, the threshold BMEP is between 3.5 and 5 bar. When the engine is pressure charged by a turbocharger or supercharger, the threshold BMEP is between 6 and 8 bar. In another embodiment, the first operating condition, in addition to a BMEP threshold, also has an engine speed which is below a threshold piston speed. The second operating condition is above the threshold BMEP or above the threshold piston speed. The threshold piston speed is between 12 and 16 m/sec. Because the piston travels both up and down when the engine completes one revolution, piston speed is computed as 2*S*N, where S is stroke and N is engine rpm. The piston speed is not constant through the revolution; the piston speed computed here is an average piston speed.

The hydrocarbon fuel can be gasoline or a mixture of gasoline with an alcohol fuel. Alternatively, the hydrocarbon fuel can be a gaseous fuel such as natural gas or propane.

Also disclosed is a method to operate an internal combustion engine, in which hydrogen supplied when a temperature of a three-way catalyst coupled to the engine exhaust is below a threshold temperature and a liquid fuel is supplied to the engine only when a temperature of the three-way catalyst is above the threshold temperature. The liquid fuel may be gasoline, alcohol, or a combination thereof. The threshold temperature is a light-off temperature of the three-way catalyst. In one embodiment, not only is the temperature above the light-off temperature of the catalyst, but the engine produces more than a threshold BMEP when the liquid fuel is supplied.

### BRIEF DESCRIPTION OF THE DRAWINGS

The advantages described herein will be more fully understood by reading an example of an embodiment in which the invention is used to advantage, referred to herein as the Detailed Description, with reference to the drawings, wherein:

FIG. 1 is a schematic of an engine having two fuel supplies;

FIGS. 2a-b show engine operating maps of BMEP and piston speed, showing operating zones for two fuels;

FIG. 3 shows an engine operating map of BMEP and catalyst temperature, showing operating zones for two fuels; and

FIGS. 4 and 5 show timelines of transitions from hydrogen to gasoline.

### DETAILED DESCRIPTION

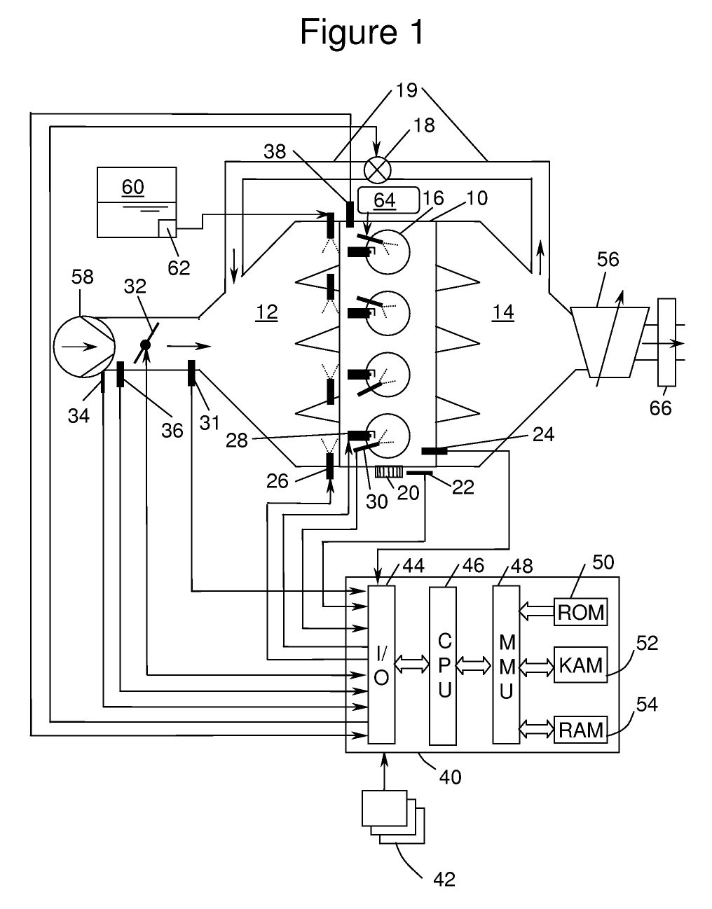

A 4-cylinder internal combustion engine 10 is shown, by way of example, in FIG. 1. Engine 10 is supplied air through intake manifold 12 and discharges spent gases through exhaust manifold 14. An intake duct upstream of the intake manifold 12 contains a throttle valve 32 which, when actuated, controls the amount of airflow to engine 10. Sensors 34 and 36 installed in intake manifold 12 measure air temperature and mass air flow (MAF), respectively. Sensor 31, located in intake manifold 14 downstream of throttle valve 32, is a manifold absolute pressure (MAP) sensor. A partially closed throttle valve 32 causes a pressure depression in intake manifold 12 compared to the pressure on the upstream side of throttle valve 32. When a pressure depression exists in intake manifold 12, exhaust gases are caused to flow through exhaust gas recirculation (EGR) duct 19, which connects exhaust manifold 14 to intake manifold 12. Within EGR duct 19 is EGR valve 18, which is actuated to control EGR flow. Hydrogen fuel is supplied to engine 10 by fuel injectors 30, injecting directly into cylinders 16, and port injectors 26 injecting a liquid fuel into intake manifold 12. This arrangement is shown by way of example and is not intended to be limiting. In other embodiments include having port injectors 26 supplying hydrogen fuel and direct injectors 30 supplying liquid fuel. Alternatively, both fuels are supplied through direct fuel injectors. In yet another embodiment both fuels are supplied by port injectors. The fuel other than hydrogen, in another embodiment, is a gaseous hydrocarbon fuel such as methane. Each cylinder 16 of engine 10 contains a spark plug 28. The crankshaft (not shown) of engine 10 is coupled to a toothed wheel 20. Sensor 22, placed proximately to toothed wheel 20, detects engine 10 rotation. Other methods for detecting crankshaft position may alternatively be employed.

In one embodiment, the engine is pressure charged by a compressor 58 in the engine intake. By increasing the density of air supplied to engine 10, more fuel can be supplied at the same equivalence ratio. By doing so, engine 10 develops more power. Compressor 58 can be a supercharger which is typically driven off the engine. Alternatively, compressor 58 is connected via a shaft with a turbine 56 disposed in the engine exhaust. Turbine 56, as shown in FIG. 1, is a variable geometry turbine; but, may be, in an alternative embodiment, a non-variable device. In another embodiment, the engine is naturally aspirated, in which embodiment elements 56 and 58 are omitted. Downstream of turbine 56 is three-way catalyst 66. Three-way catalyst 66 can alternatively be place upstream of turbine 56 for faster light-off. Alternatively, catalyst 66 is a lean NOx trap or lean NOx catalyst having the capability to reduce NOx at a lean equivalence ratio.

Two fuel tanks, 60 and 64, supply the two fuels. In the embodiment shown in FIG. 1, tank 60 contains liquid fuel and tank 64 contains hydrogen. However, as described above, the inventors of the present invention contemplate a variety of possible fuel combinations, with the appropriate fuel storage container included. In tank fuel pump 62 pressurizes liquid fuel. Fuel tank 64 is under high pressure. Typically, no pressurization is required, but a pressure regulator may be used.

It is known in the prior art to make transitions between engine operating modes. For example, in stratified charge gasoline engines, transitions between lean, stratified to premixed, stoichiometric operation are known to pose a challenge because the equivalence ratio changes from lean to rich abruptly, with the fuel remaining constant. In the present invention, the equivalence ratio also changes abruptly when switching fuels because the best combination of hydrogen operating characteristics are achieved at an equivalence ratio less than 0.5; whereas, desirable fuel and emission operating characteristics are achieved with other fuels (hydrocarbons, alcohols, etc.) at an equivalence ratio of 1.0. Fuel transitions can be accomplished in a single cycle, whereas air lags thereby causing challenges during the transitions. The present invention differs from prior art transitions in stratified charge engines because in the present invention the fuel changes as well as the equivalence ratio.

It is known in the prior art to operate bi-fuel engines in which transitions are made between two fuels, such as between gasoline and propane or between gasoline and ethanol. However, most known fuels (gaseous hydrocarbons, liquid hydrocarbons, and alcohols) have a narrow range of flammability, equivalence ratio (roughly 0.65 lean limit and 1.7 rich limit) compared with hydrogen fuel (roughly 0.10 lean limit and 3 rich limit). Because most fuels cannot combust robustly at very lean equivalence ratios, their stable, lean operation occurs in a region in which high NOx is produced. Thus, most fuels, except hydrogen, are operated at stoichiometric, i.e., equivalence ratio of 1. Because very lean mixtures of hydrogen combust robustly, the amount of NOx produced is small allowing such lean operation without a great emission concern. Even though hydrogen can be combusted in a wide range of equivalence ratios, in an internal combustion engine, it is used in the 0.15 to 0.5 equivalence ratio range because when operating richer than 0.5 equivalence ratio harsh combustion and autoignition of the hydrogen results, conditions which are to be avoided. Thus, a bi-fuel engine, in which one of the two fuels is hydrogen, when making a transition from hydrogen to gasoline, a switch from an equivalence ratio of about 0.5, or leaner, to 1.0 occurs.

In summary, the present invention distinguishes between the prior art transitions between stratified, lean operation and stoichiometric operation, as discussed above, in that both a transition in equivalence ratio and fuel type occurs. The present invention distinguishes between the prior art bi-fuel transition because when one of the fuels is hydrogen, according to the present invention, switching among combustion modes results in an increase in both fuel type and equivalence ratio; whereas, in the prior art in which neither of the two fuels is hydrogen, the equivalence ratio does not substantially change when the fuel type changes.

Gaseous fuels that are delivered by an electronic fuel injector can be turned on, off, or anywhere in between in a single cycle with the only transient issue being inventory of fuel in the intake manifold in the case of the fuel injector being located in the intake port. Liquid fuels that are supplied directly to the combustion chamber (direct injected) can be affected in a single cycle. However, liquid fuels that are supplied into the intake port (port injected) present some difficulties due to fuel films that form on port surfaces. That is, when activating injectors, some of the fuel sprayed wets manifold walls and does not enter the combustion chamber directly. When deactivating liquid, port injectors, the fuel films on the walls remaining on intake port walls are removed and are inducted into the combustion chamber; this fuel inventory takes several intake events to empty. For example, changing the amount of air being inducted into a cylinder abruptly presents an issue as it takes several engine cycles for a manifold to fill or empty. Thus, the transition from one fuel to the other takes at least several engine cycles. In one embodiment, a switch between fuels is accomplished over tens of cycles.

In one embodiment, both fuels are delivered during the transition period while the supplied air is adjusted to the new operating condition. It is known to those skilled in the art that hydrogen, when used to supplement gasoline (or other hydrocarbon fuel) facilitates combustion at a substantially leaner equivalence ratio than would be possible with gasoline alone.

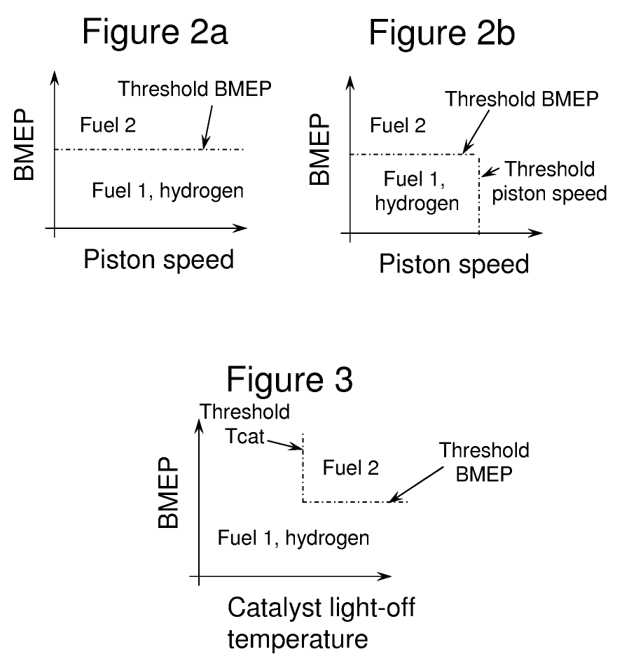

In FIG. 2a, it is shown the fuel 2 is used when the threshold BMEP is exceeded. This threshold is associated with an equivalence ratio of the hydrogen which is greater than a desirable level, e.g., 0.5. That is, to produce more than the threshold BMEP, the hydrogen equivalence ratio would exceed 0.5. In FIG. 2b, an additional constraint is placed on hydrogen operation in that when the piston speed exceeds a certain threshold, the engine transitions to fuel 2.

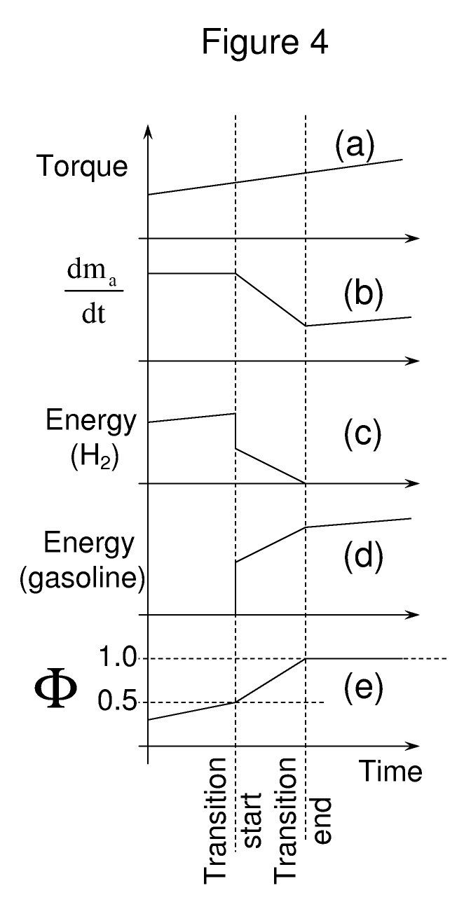

When cold, the engine starts on hydrogen fuel, which presents no cold start vaporization and mixing issues such as a liquid fuel. In FIG. 3, fuel 2 is only used when both the catalyst has attained its light-off temperature and the threshold BMEP has been exceeded.

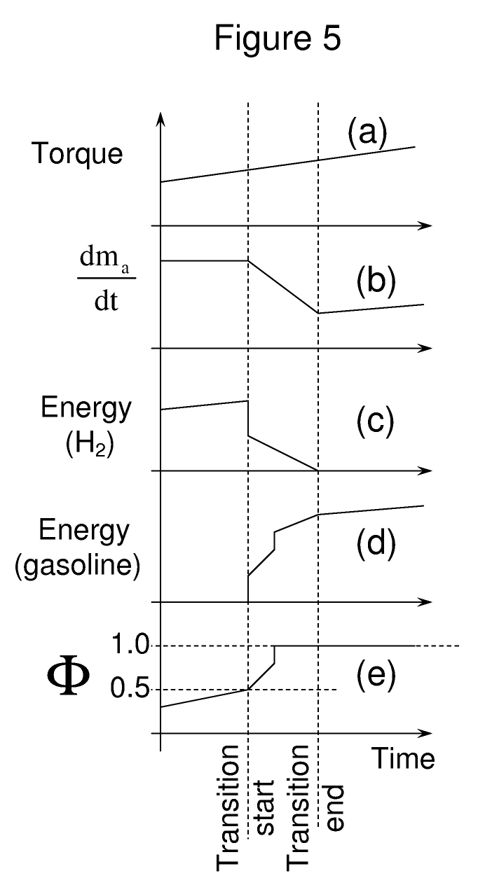

In FIG. 4, one embodiment of a transition from hydrogen to gasoline is shown in a timeline. Before the transition, hydrogen is used; after the transition, gasoline is used; and during the transition, a combination of the two fuels is used. In the top graph, a, torque is increasing. In the bottom graph, e, the equivalence ratio, Φ, is less than 0.5 prior to the transition. As discussed above, a transition from hydrogen to gasoline is desirable when the hydrogen equivalence ratio approaches 0.5; thus, the transition is initiated. In graph c, the amount of hydrogen provided increases prior to the transition to provide the increased torque of graph a. Prior to the transition, the air delivery rate, dmₐ/dt of graph b, remains constant with the additional torque provided by increasing hydrogen. At transition initiation, the throttle is partially closed and the amount of air is decreased. Air supply decreases such that the air supplied by the end of the transition is that required to provide Φ=1.0, which is the desired equivalence ratio for all fuels, except hydrogen. One of the reasons that there is a transition period is that air delivery cannot be changed in one engine cycle. Instead, even when the throttle is opened rapidly, it takes several engine cycles for the manifold to fill and the desired amount of air to be provided to the engine. Because the air is more than desired right after the start of the transition, hydrogen supply is continued. It is known by those skilled in the art, that by supplementing a conventional fuel with hydrogen, that the conventional fuel can robustly combust at an equivalence ratio at which it is unable to do so without the presence of hydrogen. Thus, the hydrogen continues through the transition period, until the equivalence ratio achieves the desired 1.0, at which time the hydrogen supply is discontinued. Alternatively, but not shown in the Figure, the hydrogen supply could be discontinued when the equivalence ratio reaches a ratio that the conventional fuel, e.g., gasoline, can robustly combust, such as greater than 0.8. Gasoline supply is initiated at the start of the transition. However, as discussed above, because the air cannot be reduced as quickly as desired, the hydrogen is continued into the transition period to ensure the combustion. Through the transition period, the gasoline is increased and the hydrogen decreased, as well as the air decreasing, so that by the end of the transition period, the gasoline operation takes over with no hydrogen assistance.

In FIG. 5, an alternative embodiment is shown in which the initial portion of the transition is similar to that shown in FIG. 4. However, at a point during the transition, the equivalence ratio is bumped up to 1.0 and maintained at 1.0 for the remainder of the transition. This is done to avoid the high NOx region of 0.85-0.90 phi. However, during this transition period of 1.0 equivalence ratio, the hydrogen supply is continuously being decreased and the gasoline supply is increased. At the end of the transition, hydrogen supply has ceased.

In the above discussion, a hydrogen-to-gasoline transition is described. However, the reference to gasoline is provided by way of example and is not intended to be limiting. Furthermore, the transition occurring at Φ=0.5 is also by way of example. The actual transition may occur at slightly lower or higher equivalence ratios than exactly 0.5.

A transition from a higher torque to a lower torque in which gasoline (or other fuel) operation is transitioned to hydrogen operation can be accomplished in the reverse of what is shown in FIGS. 4 and 5. If the fuel other than hydrogen is a liquid fuel and is port injected, the inventory of the fuel in the intake manifold is accounted for to provide the desired fuel into the combustion chamber.

While several modes for carrying out the invention have been described in detail, those familiar with the art to which this invention relates will recognize alternative designs and embodiments for practicing the invention. The above-describe embodiments are intended to be illustrative of the invention, which may be modified within the scope of the following claims.

1. A method to operate an internal combustion engine, comprising:
supplying a first fuel to the engine when the engine is at a first operating condition, said first fuel being substantially 100% hydrogen; and
supplying a second fuel to the engine when the engine is at a second operating condition, said second fuel being a hydrocarbon fuel wherein said first operating condition is below a threshold BMEP and below a threshold piston speed.

2. The method of claim 1 wherein said engine is naturally aspirated and said threshold BMEP is between 3.5 and 5 bar.

3. The method of claim 1 wherein said engine is pressure charged and said threshold BMEP is between 6 and 8 bar.

4. The method of claim 1 wherein said second operating condition is above a threshold piston speed.

5. The method of claim 4 wherein said threshold piston speed is between 12 and 16 m/s.

6. The method of claim 1 wherein said second fuel is gasoline.

7. The method of claim 1 wherein said second fuel is a mixture of gasoline and alcohol.

8. The method of claim 1 wherein said second fuel is natural gas.

9. A method to operate an internal combustion engine, comprising:
supplying only hydrogen fuel to the engine when a temperature of a three-way catalyst coupled to the engine exhaust is below a threshold temperature; and
supplying a liquid fuel to the engine when a temperature of said three-way catalyst is above said threshold temperature.

10. The method of claim 9 wherein said liquid fuel is gasoline.

11. The method of claim 9 wherein said liquid fuel contains alcohol.

12. The method of claim 9 wherein said threshold temperature is a light-off temperature of said three-way catalyst.

13. (canceled)

14. (canceled)

15. (canceled)

16. The method of claim 3 wherein a turbocharger is coupled to the engine to provide pressure charging.

17. The method of claim 3 wherein a supercharger is coupled to the engine to provide pressure charging.

18. An internal combustion engine having first and second fueling systems, comprising:
an electronic control unit electronically coupled to said first and second fueling systems and to said engine, said electronic control unit commanding that a first fuel only be supplied when a first engine operating condition is encountered and commanding that a second fuel only be supplied when a second engine operating condition is encountered, said first fuel being hydrogen and said second fuel being a liquid fuel, said first operating condition having a BMEP below a threshold BMEP and a piston speed below a threshold piston speed and said second operating condition having a BMEP above said threshold BMEP.

19. The engine of claim 18 wherein said second operating condition being above said threshold piston speed.

20. The engine of claim 19 wherein said threshold speed is in the range of 12 and 16 m/s.

21. The method of claim 1 wherein said second operating condition is above said threshold BMEP.

22. The engine of claim 18 wherein said engine is naturally aspirated and said threshold BMEP is between 3.5 to 5 bar.

23. The engine of claim 18 wherein said engine is pressure charged and said threshold BMEP is between 6 and 8 bar.
